(19) United States
(12) Patent Application Publication
(10) Pub. No.: US 2006/0063626 A1
(43) Pub. Date: Mar. 23, 2006

(54) Process of designing a timing control drive having at least one non-circular disk

(75) Inventors: Peter Kelm, Herzogenaurach (DE); Frank Rettig, Herzogenaurach (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: INA-Schaeffler KG, Herzogenaurach (DE)

(21) Appl. No.: 11/029,585

(22) Filed: Jan. 5, 2005

(30) Foreign Application Priority Data
Sep. 21, 2004 (DE) 10 2004 045 751.4

(51) Int. Cl. F16H 55/30; F16H 55/36

(52) U.S. Cl. 474/141

(57) ABSTRACT

A process for optimized design of a tension means drive having at least one non-circular pulley on an internal combustion engine, in which the pulley is controlled in position such that upon dynamic superposition of an excitation of the tension means drive during driving resulting from the pulley shape with at least one further excitation of the tension means drive, a specific overall excitation of the tension means drive results. The invention furthermore relates to a corresponding computer system.

### BACKGROUND

The invention relates to a process and a computer system for designing a timing control drive taking into account non-circular disks.

The number of power takeoffs of an internal combustion engine has greatly increased. At present it is usual that assemblies such as for example a generator, water pump, steering auxiliary pump, air conditioning compressor, fans or oil pumps are driven. To achieve a slip-free drive, an automatic tensioning system is allocated to the tension means drive. The increasing electrification of motor vehicles leads to generators of larger dimensions, which have an increased mass. The requirements for quiet running and comfort level of internal combustion engines have markedly increased, the disturbance and noise sources, for example in the engine space, being suppressed at great cost. As a result, besides the conventional design process for tension means drives, for example the increased requirements on the lifetime of the tension means are considered. The decisive quality criterion of the tension means drive is the dynamic behavior. Correspondingly, care is taken with dynamic problem setting both in the construction phase and also in the course of an application development.

A process was already known heretofore, by means of which it is possible, as a prelude to production proper, i.e., still in the development stage of a tension means drive, to make predictions about the dynamics of a positive tension means drive.

The known process is described in detail in the document, “Dynamic simulation of the automobile auxiliary assembly drive”, VDI Reports No. 1467 (1999), pp. 271-290, P. Solfrank, P. Kelm, and also in the document, “Analysis of transverse belt vibrations in automobile auxiliary assembly drives”, VDI Reports No. 1758 (2003), pp. 169-183, F. Rettig. The process is supported by generally known model elements and starts in particular from ideal circular tension means disks. The simplified consideration of ideal circular disks is accompanied by the assumption of a tension means drive with uniform transmission. Important side effects arising from non-circular disks are in fact ignored, and when not considered can also act negatively on the quiet running of the tension means drive and of the whole system in which it is incorporated.

### SUMMARY

An objective of the present invention is to provide a process for designing a tension means drive while considering non-circular disks.

Starting from these considerations, the present invention, with special consideration of non-circular disks, provides a process for designing a tension means drive having at least one non-circular disk, and a computer system for such design.

According to the invention, a process is provided of designing a tension means drive having at least one non-circular disk, in which the disk is accordingly positioned in a controlled manner such that with dynamic superpositioning of an excitation of the drive resulting from the disk shape during the operating state with at least one further excitation of the tension means drive, a specific total excitation of the tension means drive results.

In the context of the present invention, “non-circular” means that the radius of the disk is not constant, which can be accompanied by a non-uniform transmission. Due to a non-circular disk, the tension means drive, particularly designed as a control drive, can undergo an excitation, i.e., a vibration excitation, which results from the disk shape, i.e., not the ideal circular shape. Through the process according to the invention, the disk is now positioned such that during the operation of the tension means drive, a resulting superposition of an excitation of the drive resulting from the disk shape and a further excitation of the timing control drive leads to a specific total excitation of the tension means drive. The tension means drive determined for a control drive or an assembly drive of an internal combustion engine can be designed either as a belt drive or as a chain drive.

In one embodiment, a minimum total excitation is realized upon superposition of an excitation resulting from the disk shape with at least one further excitation of the drive. This means that the excitation resulting due to the disk shape is superposed on at least one other excitation such that there is thereby achieved a minimization of the disturbing side effects due to the excitations. With a suitable superposition of phase-displaced excitations, an extinction can even possibly result. In another arrangement according to the invention, the excitation of the tension means drive due to the disk shape is to be used so that an optimum behavior with respect to lifetime, slip, and/or a tension means vibration is achieved.

With a further excitation, an excitation from the non-uniformity of a crankshaft of an internal combustion engine or from torque fluctuations, can, for example, be addressed.

The process according to the invention is based on a simple modeling, which as already mentioned was used in considering the dynamics of a positive tension means drive with only consideration of an ideal circular disk.

The model will be explained hereinafter with the example of a belt drive. It can be transferred according to the invention to alternative tension means drives such as for example a chain drive.

The tension means drive designed as a belt drive is to be understood in the context of the model as a planar system. The essential model elements are firstly belt pulleys with fixed rotation axes and predetermined rotary motion, belt pulleys with fixed rotation axis and a rotary degree of freedom, and also a load moment dependent on time and angle, belt runs as idealized spring-damper elements according to the so-called Kevin-Voigt model, belt runs with the possibility of transverse vibrations, belt pulleys whose rotation axis is seated on a lever which in turn rotates around a fixed fulcrum, and mechanical and hydraulic tensioning systems. Elements were furthermore considered which represent rotary connections between individual belt pulleys, such as for example torsion springs with viscous or coulomb friction, and free-running elements.

Usually a rotary motion disk of a tension means drive designed as a belt pulley is predetermined in the form of a time series or Fourier series. This is the case for a crankshaft as a rule, since it represents the vibration excitation and simultaneously a system boundary. The use of a time series is recommended when measurement values for an investigated internal combustion engine are present whose whole frequency content can be used. In such cases the concern is frequently to investigate different variants of a belt drive or the design of a tensioning system, starting from a reference configuration. In other cases of application, where the aim is the evaluation of a concept without prior starting points, it is only possible to fall back on ratings from similar internal combustion engines. Here rather, the rating of a crankshaft rotation uniformity is often meaningful in the form of a Fourier series reduced to a few harmonic terms.

There are also no problems with a mathematical representation of disks of tension means drives with rotary degree of freedom, since for these partial systems the torsion term is valid in its simplest form with known moments. To the moments transmitted by the tension means to the disk there are added the load moments for the disks of the assembly, which in practice are almost exclusively regarded as constant or cannot otherwise be given because of the lack of further information. In individual cases, load moments can be predetermined in dependence on time or position.

Independently of whether the possibility is provided of slip between belt and belt pulley, at the belt pulleys connected together by a belt run, a representation of the rotary forces with linear elastic strain behavior of the belt is relatively easy, if no transverse vibrations are permitted by the modeling and in addition ideal circular disks are the starting point. With given positions \vec{x}₁ and \vec{x}₂ of the belt pulley midpoints of two belt pulleys, the angle between the connecting line \vec{x}_{M} and the belt running direction \vec{e}_{belt}, assuming ideally circular belt pulleys, is given as:

$$α = arcsin ( \frac{{d}_{1} {r}_{1} - {d}_{2} {r}_{2}}{\vert {\vec{x}}_{M} \vert} )$$

or the free belt length “l” as
   l=|\vec{x}_{M}|cosα
with dᵢ as the respective nominal direction of pulley rotation (±1) and rᵢ as the respective pulley radius. As shown in FIG. 1, where the geometry of a belt run is shown under the precondition of an ideal circular belt pulley, a comparison of these quantities for a nominal and an actual state permits the calculation of the belt strain as:
   Δl=l_{act}−l₀+d₁r₁(α_{act}−α₀−φ₁)−d₁r₁(α_{act}−α₀−φ₂)

With the speeds of the belt pulley contact points
\vec{v}_{k,i}=\vec{v}_{M,i}+dᵢrᵢωᵢ\vec{e}_{belt}
the rate of strain can be calculated as:

$$\frac{ⅆ}{ⅆ t} Δ l = \vert {\vec{v}}_{k , 2} - {\vec{v}}_{k , 1} \vert$$

On the basis of a Kevin-Voigt model for the belt with length-specific stiffness or damping values EA or DA, the average belt force is obtained:

$$F = max ( 0 , {F}_{0} + \frac{EA}{{l}_{0}} Δ l + \frac{DA}{{l}_{0}} \frac{ⅆ}{ⅆ t} Δ t )$$

A modeling of belt transverse vibrations as string vibrations of free runs is possible without consideration of damping terms, as a partial differential equation for describing the forces acting on an infinitesimal belt element:

$$ρ A \frac{{\partial }^{2} y}{\partial {t}^{2}} + 2 ρ Av \frac{{\partial }^{2} y}{\partial x \partial t} - ( F - ρ {Av}^{2} ) \frac{{\partial }^{2} y}{\partial {x}^{2}} + El \frac{{\partial }^{4} y}{\partial {x}^{4}} = 0$$

Longitudinal belt vibrations are ignored here.

The symbols used mean in detail:
ρA length-specific mass
y deflection of the belt element perpendicular to the tangent at the belt pulley
x length coordinate of the belt element
v belt speed in the longitudinal direction
F longitudinal belt force
El bending stiffness of the belt.

Using initial functions for a transverse motion corresponding to the so-called Ritz process
y(x,t)=w^{T}(x)q(t)
with a vector “w” of purely location-dependent initial functions and a vector “q” of purely time functions which represent degrees of freedom in the overall mechanical model, a representation is obtained, transformed into a customary differential equation representation:
M\ddot{q}+(G+D)\dot{q}+Kq+0
with
M=μ∫ww^{T}dx
G=2π∫ww^{T}dx
D=δ∫ww^{T}dx
K=(F−μv²)∫w¹w^{1T}dx+El∫wⁿw^{nT}dx

$$F = {F}_{0} + \frac{EA}{l} ( \frac{1}{2} {q}^{T} \int {w}^{1} {w}^{1 T} ⅆ xq + Δ l ) + \frac{DA}{l} ( qT \int {w}^{1} {w}^{1 T} ⅆ x \dot{q} + \frac{ⅆ}{ⅆ t} + Δ t )$$

A damping proportional to speed was added, the matrix of which was formed in dependence on the stiffness matrix. Fulcrums are assumed to be stationary here. For calculation of a longitudinal belt force, an analogy can be seen to the calculation of belt forces without transverse vibrations, only length changes and corresponding strain speeds due to the transverse vibrations are added.

As an initial function for a transverse vibration, sine functions are used, which for an integer multiple of half a wavelength correspond to exactly the free length of a belt run, namely

$${w}_{i} ( x ) = sin ( ⅈ \frac{π}{{l}_{0}} * x )$$

Locally integral matrices can thereby be given explicitly. For the j-th initial function there thereby results the following conventional differential equation:

$$\frac{μ {l}_{0}}{2} {\ddot{q}}_{j} + 4 μ {v}_{j} {\sum }_{k = {mod}_{2} ( j ) + 1}^{n , {nep}^{2}} \frac{k \dot{{q}_{k}}}{{j}^{2} - {k}^{2}} + δ \frac{( {jπ}^{2} )}{2 {l}_{0}} {\dot{q}}_{j} + [ ( F - μ {v}^{2} ) \frac{{( jπ )}^{2}}{2 {l}_{0}} + El \frac{{( jπ )}^{4}}{2 {l}_{0}^{3}} ] {q}_{j} = 0$$

The cited document is referred to regarding the model elements of mechanical tensioners and hydraulic tensioners.

Classical integration processes with step width control are used for an integration of the said equations of motion. Besides the known Runge-Katta method of 4th or 5th order, in many comparative calculations the method of Stoer and Bulirsch has above all been found to be efficient for the cited model. In all implemented processes, account was taken of side conditions and likewise equidistant result output. The described system of model elements can be substantially implemented in an object-oriented manner, for example in the program language C++, in a computer program running on a computer. The individual elements can be freely ordered and combined, so that optional configurations can be generated. The description of individual operating states to be investigated is oriented to such a procedure, so that it is possible to successively process optionally many operating cases in a calculation run. Suitable parameters have to be determined or set for the contained partial models. The necessary parameters can be arranged in three classes, namely standard parameters such as masses, inertial moments, load moments of the assembly and geometrical measurements and quantities which can only be determined with a certain additional cost, or those which have to be created exclusively for the model.

The last-named quantities can for example be obtained by a measurement on a prototype. A third class of model parameters are those which are largely not measurable, such as for example damping parameters of the belt, or frictional values in contact between belt and belt pulley. For problem solving, reference is made to equalization calculations: starting from an application which comes closest to the target system and for which measurements are available, measurement and calculation are brought into agreements by parameter matching, only for an overall system. A parameter set close to reality is determined in this way.

In the process according to the invention, however, the starting point is not ideal circular belt pulleys but at least one non-circular belt pulley or disk. While the strain with ideal circular pulleys can easily be formulated as a linear equation, when considering non-circular pulleys they have to be described by a more complex expression.

With the assumption of ideal circular pulleys or disks, numerous simplifications can be made in the corresponding calculations. Thus, for example, the run geometry between stationary circular pulleys is approximately constant. The same holds for the length and positioning of corresponding wrapping arcs of the disks. A belt or a chain runs, for example, off a first disk and simultaneously off a second disk. It is assumed that both disks have an ideal circular shape, that is, the first disk has a fixed radius r₁ and the second disk has a fixed radius r₂. The first disk now rotates through an angle β₁ while the belt or chain runs onto it. The second disk rotates through an angle β₂ while the belt or chain runs off it. There results a length change of the belt or chain βl which can be calculated as follows:
Δl=r₁β₁−r₂β₂

The strain then corresponds to Δl/l.

Considering non-circular disks, according to an embodiment of the process according to the invention, the disk shape of the non-circular disk is now described by an angle-dependent radius.

In a further embodiment, with a rotation of the disk, an arc length of a tension means running over at least one non-circular disk is described as the integral relationship of the angle-dependent radius with the angles swept over when the disk rotates. The tension means can be a belt or a chain, for example, and the terms pulley or disk are intended to include belt pulleys and chain gear rings.

Furthermore in another possible embodiment of the process according to the invention, the arc length is described as a dynamical quantity by means of dynamically changing angles swept over as the pulley rotates.

The following description in terms of a belt also holds analogously for other tension means.

A strain, e.g. of a belt, which runs onto a first belt pulley and simultaneously runs off a second belt pulley, is given as the difference between the arc lengths over which the belt runs on the respective belt pulleys. Thus a strain of a belt running over the non-circular pulleys is described by a functional relationship belt running over the non-circular pulleys is described by a functional relationship of the angle-dependent radius with the angles swept through by the belt pulley with the strain. This means that the strain can now be determined only by means of a complex formulation in which the strain has to be determined for each suitable time interval, in order to be able to describe the dynamics of the belt drive. This widened formulation of the strain and correspondingly of the radius is now, according to the invention, used in the corresponding model equations and model formulations of the model mentioned and briefly described at the beginning for belt drives with ideal circular belt pulleys. Thereby there are considered, besides the changed formulation for the strain, also the permanent change of the geometry which arises with the non-circular belt pulley shape. The widened formulation of the rotation and of the angle-dependent radius in the presence of at least one non-circular pulley acts, among others, directly on the belt force, on the belt strain, and thereby lastly in the equations of motion of the abovementioned model of the overall system, reference to which is fully made here. Furthermore, the model is fully included within the scope of the invention.

The present invention furthermore relates to a computer system for modeling a timing control drive having at least one non-circular with input means for inputting model elements and parameters describing the control drive and with calculating means for calculating the specific excitation of the timing control drive resulting from the dynamical superposition of an excitation of the control drive resulting from the pulley shape during the operation of the drive of the control drive with at least one further excitation of the control drive, by means of which the pulley is controlled in position.

In an embodiment of the computer system according to the invention, a minimum excitation is calculated as the resulting specific excitation.

In a further embodiment of the computer system according to the invention, the pulley shape of the non-circular pulley is described by an angle-dependent radius.

It is furthermore proposed in another embodiment of the computer system according to the invention to describe a strain of a tension means running over the non-circular pulley as a functional relationship of the angle-dependent radius and the strain, of the angles swept over the belt pulley.

Furthermore in a further embodiment of the computer system accord-ing to the invention, the strain is described as a dynamic quantity by means of angles, dynamically changing with strain, swept over the pulley.

Moreover the present invention provides a product for performing the process according to the invention, the product being a computer program with program code, which is suitable when the computer program is run on a computer for performing a process according to the invention.

The computer program according to the invention is stored, for example, on a computer-readable medium.

The present invention furthermore relates to a computer-readable data carrier with a computer program stored thereon and comprising a program code which is suitable for performing a process according to the invention when the computer program runs on a computer.

Furthermore a computer system with a memory means is provided, in which a computer program with program code is stored, which when the computer program runs on a computer is suitable for performing a process according to the invention.

### BRIEF DESCRIPTION OF THE DRAWINGS

Further advantages and embodiments of the invention will become apparent from the specification and the accompanying drawings.

It will be understood that the features named hereinabove and yet to be explained can be used, not only in the respective given combinations, but also alone, without departing from the scope of the invention.

The invention is described in detail hereinafter with reference to the drawings and by means of a preferred embodiment in comparison with an example from the prior art.

FIG. 1 is a schematic diagram of a belt geometry for the prior known calculation noted above

FIG. 2 is a schematic diagram of a belt drive with two ideal circular belt pulleys, which are coupled together by means of a belt running over them.

FIG. 3 is a schematic diagram of a belt drive with two non-circular belt pulleys, which likewise are coupled together by a belt running over them.

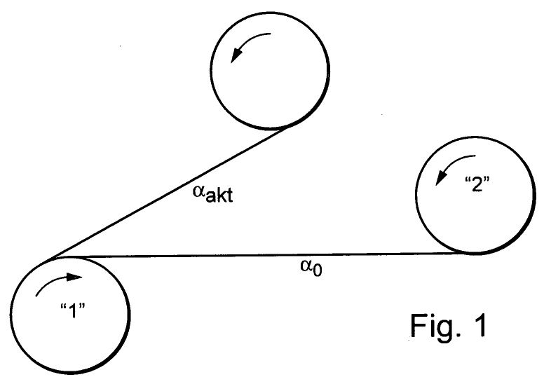

### DETAILED DESCRIPTION OF THE PREFERRED EMBODIMENTS

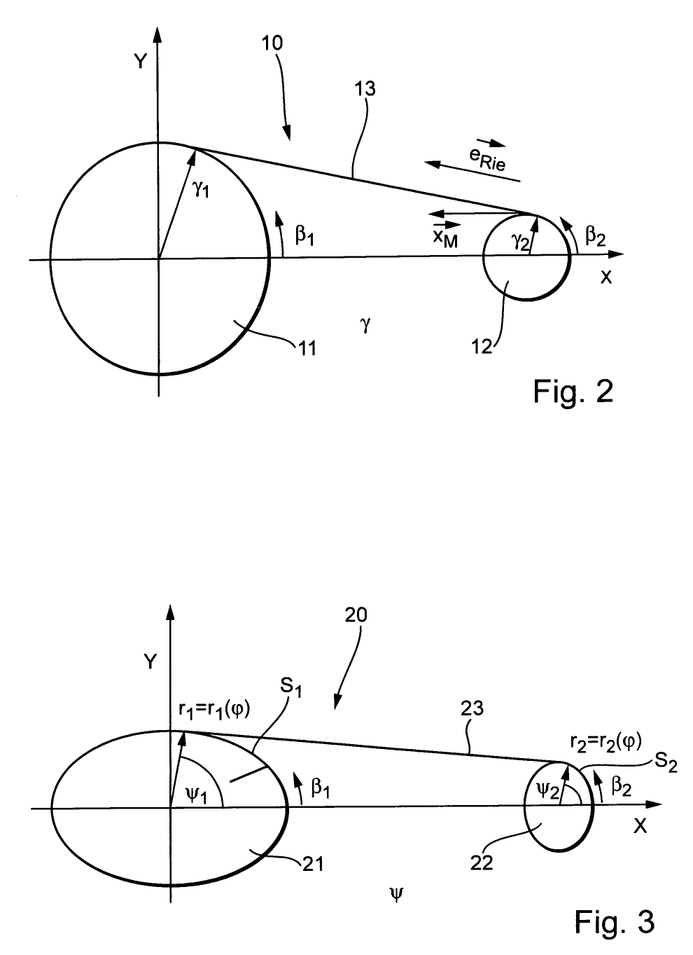

FIG. 2 shows a belt drive 10 with two ideal circular belt pulleys 11 and 12. The belt drive 10 is understood to be a planar system. The belt pulleys 11 and 12 in the present example are respectively rotatable about a fixed axis. In general it is however also conceivable that the belt pulleys themselves can execute a transverse motion, which is not considered here for the sake of clarity. The belt pulley 11 has a constant radius r₁, while the belt pulley 12 has a constant radius r₂. In the case shown here, r₁ is greater than r₂. The belt pulley 11 is now rotated for example through an angle β₁. The belt pulley 11 drives the belt pulley 12 so that the belt pulley 12 is thereby rotated through an angle β₂. Consequently a belt 13 which runs over the belt pulleys 11 and 12 is rotated by an amount Δl. Δl is then given very simply by the following equation:
Δ1=r₁β₁−r₂β₂
where r₁β₁ is the arc length run over by the belt on the belt disc 11 and r₂β₂ is the arc length run over by the belt on the belt disc 12.

FIG. 3 shows, in contrast, a belt drive 20 with two non-circular belt pulleys 21 and 22. The belt pulleys 21 and 22 are each rotatable about a fixed axis. Furthermore a belt 23 is shown which runs over the belt pulleys 21 and 22 and couples these together. If the belt pulley rotates conter-clockwise as shown here through an angle ψ₁, the belt 23 runs on the belt pulley 21. Simultaneously the belt pulley 22 is rotated through an angle ψ₂ and the belt 23 runs off the belt pulley 22. The arc length s₁ or s₂, respectively, over which the belt 23 runs on the respective belt pulleys 21 and 22 is given as the integral over the differential ds₁ or ds₂ of the arc length, which in polar coordinates corresponds to the following expression:

$$\begin{matrix}\begin{matrix}{s}_{1} = {\int }_{0}^{{v}_{1}} ⅆ {s}_{1} \\ {ds}_{1} = \sqrt{( {{r}_{1} ( φ )}^{2} + {{r}_{1}^{2} ( φ )}^{2} )} dφ\end{matrix} \\ {s}_{2} = {\int }_{0}^{{v}_{2}} ⅆ {s}_{2} \\ {ds}_{2} = \sqrt{( {{r}_{2} ( φ )}^{2} + {{r}_{2}^{2} ( φ )}^{2} )} dφ\end{matrix}$$

r₁(φ) is the angle-dependent radius of the belt pulley 21 and r₂(φ) is the corresponding angle-dependent radius of the belt pulley 22. Based on the different arc lengths of the belt 23 running over the belt pulleys 21 or 22, a strain Δl of the belt 23 results:

$$Δ l = {\int }_{0}^{{ψ}_{1}} \sqrt{( {{r}_{1} ( φ )}^{2} + {{r}_{1}^{′} ( φ )}^{2} )} dφ - {\int }_{0}^{{ψ}_{2}} \sqrt{( {{r}_{2} ( φ )}^{2} + {{r}_{2}^{′} ( φ )}^{2} )} dφ$$

The obtained integrals have to be solved for each suitable interval in order to be able to adequately describe the dynamics of the belt drive. The integrals can alternatively be solved beforehand or replaced by an adequate approximation such as suitable polygons, for example.

In the use of this expression, expanded for example to non-circular belt pulleys, in the process for optimized excitation of belt drives already known for ideal circular belt pulleys and mentioned at the beginning, the effects resulting from the pulley shape can be considered and used with respect to an optimum excitation of the corresponding belt drive. The resulting permanent change of geometry resulting from the pulley shape can also be considered.

1. Process for designing a tension means drive having at least one non-circular disk, in which the disk is controlled in position such that with dynamic superpositioning of an excitation of the tension means, resulting from a disk shape during operation of the tension means drive, on at least one further excitation of the tension means drive, a specific overall excitation of the tension means drive results.

2. Process according to claim 1, in which a minimum excitation is realized as the specific total excitation.

3. Process according to claim 1, in which as the at least one further excitation of the tension means drive, an excitation produced by non-uniformity of a crankshaft of an internal combustion engine is used.

4. Process according to claim 1, wherein the disk shape of the non-circular disk is described by an angle-dependent radius.

5. Process according to claim 4, wherein with a rotation of the disk, an arc length of the pulley over which the tension means runs, extending over the at least one non-circular disk, is described as an integral relationship of an angle-dependent radius with angles swept over upon rotation of the disk.

6. Process according to claim 5, wherein the arc length is described as a dynamic quantity by means of dynamically changing angles upon rotation of the disk.

7. Computer system for modeling a tension means drive having at least one non-circular disk comprising input means for input of model elements and parameters describing the tension means drive and calculation means for calculating a resulting specific excitation of the tension means drive resulting from a dynamic superposition of an excitation of the tension means drive resulting from a disk shape during operation of the tension means drive with at least one further excitation of the tension means drive, through which the disk is controlled in position.

8. Computer system according to claim 7, wherein a minimum excitation is calculated as a resulting specific excitation.

9. Computer system according to claim 8, wherein the disk shape of the non-circular disk is described by an angle-dependent radius.

10. Computer system according to claim 9, wherein a strain of a tension means running over the non-circular disk is described as a functional relationship of the angle-dependent radius and of the angles swept over upon rotation of the disk.

11. Computer system according to claim 10, wherein strain is described as a dynamic quantity by means of angles, dynamically changing with the strain, swept over by the disk.

12. Product for performing the process according to claim 1, wherein the product is a computer program with program code, which when the computer program is run on a computer is suitable for performing the process.

13. Product according to claim 12, which is stored on a computer-readable medium.

14. Computer-readable data carrier with a computer program stored thereon which includes program code, which when the computer program is run on a computer is suitable for performing a process according to claim 1.

15. Computer system with a memory means in which a computer program with program code is stored, which when the computer program is run on a computer is suitable for performing a process according to claim 1.
